(19) United States
(12) Patent Application Publication
(10) Pub. No.: US 2004/0268337 A1
(43) Pub. Date: Dec. 30, 2004

(54) Allowing firmware to borrow a processor

(76) Inventor: Bradley G. Culter, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/685,287

(22) Filed: Oct. 14, 2003

Related U.S. Application Data
(60) Provisional application No. 60/483,885, filed on Jun. 30, 2003.
(60) Provisional application No. 60/483,670, filed on Jun. 30, 2003.

(51) Int. Cl. G06F 9/44

(52) U.S. Cl. 717/168

(57) ABSTRACT

One embodiment of the invention is a method for changing control of a processor that is in an active state under the control of an operating system to a borrowed state wherein the processor is under control of firmware, comprising sending a request for a change in control to the operating system, deciding, by the operating system, whether to grant the request, placing the processor in a transitional state that is different from the active state, if the request is granted, and sending, by the operating system, an interrupt signal to move the processor from the transitional state into the borrowed state.

### CROSS-REFERENCE TO RELATED APPLICATIONS

This application claims priority benefit of U.S. Provisional Patent Application No. 60/483,885 entitled “ALLOWING FIRMWARE TO BORROW A PROCESSOR,” filed Jun. 30, 2003, the disclosure of which is hereby incorporated herein by reference. This application is related to co-pending and commonly assigned U.S. patent application Ser. No. 10/446,950 entitled “SYSTEM AND METHOD FOR GENERATING ACPI MACHINE LANGUAGE TABLES,” filed May 28, 2003, and U.S. Provisional Patent Application Ser. No. 60/483,670 entitled “SYSTEM AND METHOD FOR DEVELOPMENT OF FIRMWARE,” filed Jun. 30, 2003, and U.S. patent application Ser. No. [47607-P589U.S. Pat. No. 1,020,5485 (100200410-2)] entitled “SYSTEM AND METHOD FOR DEVELOPMENT OF FIRMWARE,” filed concurrently herewith, the disclosures of which are hereby incorporated herein by reference.

### FIELD OF THE INVENTION

This application relates in general to a computer system and in specific to a system and method that permits firmware to borrow a processor from the operating system.

### DESCRIPTION OF THE RELATED ART

In a computer system that includes an Itanium Processor Family (IPF) chip, the processors are controlled by the operating system. Moreover, the processors cannot be currently removed from the control of the operating system according to the current standard and the operating system protocols. IPF chips are produced by Intel.

FIG. 1 depicts a block diagram of a firmware model 100 for an IPF system. The firmware has three components that separate the operating system (OS) 101 from the processors 102 and the platform 103. The firmware, in general, isolates the OS 101 and other higher level software (not shown) from implementation differences in the processors 102 and the platform 103. The platform 103 includes all of the non-processor hardware. One firmware is the processor abstraction layer (PAL) 104. This layer includes processor implementation specific features and is part of the Itanium processor architecture. PAL 104 operates independently of the number of processors. Another firmware is the platform/system abstraction layer (SAL) 105. SAL 105 includes the platform specific features. The last firmware is the extensible firmware interface (EFI) 106. This layer is the platform binding specification layer that provides a legacy-free application programming interface (API) to the operating system. PAL 104, SAL 105, and EFI 106 together provide system initialization and boot, machine check abort (MCA) handling, platform management interrupt (PMI) handling, and other processor and system functions which would vary between implementations. Additional information on IPF systems may be found in Intel manuals “Intel Itanium Architecture Software Developer's Manual,” Vol. 2, ‘System Architecture,’ Rev. 2.0, Doc. No. 245318-003, December 2001, and Doc. No. 248699-005, Specification Updated August 2001, and “Itanium Processor Family System Abstraction Layer Specification,” Doc. No. 245359-005, July 2001, both of which are incorporated herein by reference.

A common specification used by the OS is the advanced configuration and power interface (ACPI) 107. This specification defines an industry standard interface that enables the OS to direct motherboard configuration and system power management, which is referred to as operating system directed configuration and power management (OSPM). Additional information on ACPI may be found in the ACPI specification “Advanced Configuration and Power Interface Specification,” Compaq/Intel/Microsoft/Phoenix/Toshiba, Rev. 2.0b, Oct. 11, 2002, which is incorporated herein by reference. Consequently, in a IPF system employing ACPI, the OS maintains control over the processor(s).

### BRIEF SUMMARY OF THE INVENTION

One embodiment of the invention is a method for changing control of a processor that is in an active state under the control of an operating system to a borrowed state wherein the processor is under control of firmware, comprising sending a request for a change in control to the operating system, deciding, by the operating system, whether to grant the request, placing the processor in a transitional state that is different from the active state, if the request is granted, and sending, by the operating system, an interrupt signal to move the processor from the transitional state into the borrowed state.

### BRIEF DESCRIPTION OF THE DRAWINGS

FIG. 1 depicts a block diagram of a firmware model for the IPF processor chip.

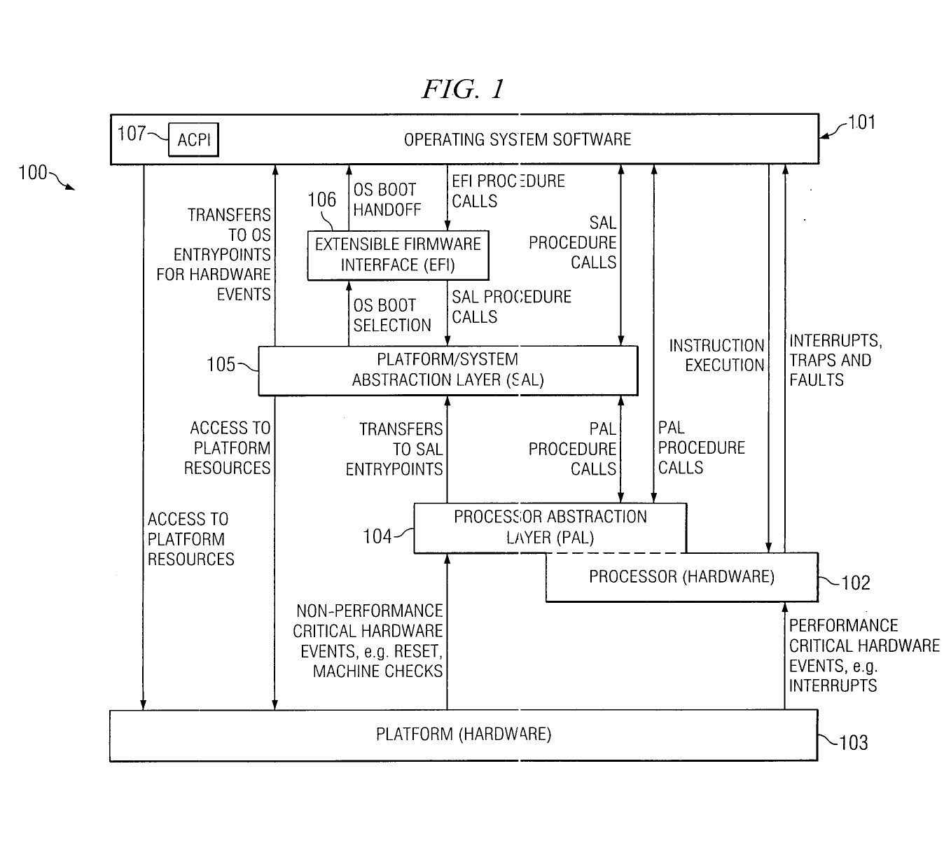

FIG. 2 depicts an example of a method of operation according to embodiments of the invention.

FIG. 3 depicts a state diagram for a processor according to embodiments of the invention.

FIG. 4 depicts an example of an arrangement of a system or platform according to embodiments of the invention.

### DETAILED DESCRIPTION

Embodiments of the invention allow firmware to borrow control of one or more system processors from the operating system. Embodiments of the invention allow may operate with the IPF architecture. The firmware may then return the borrowed processor(s) to the operation system upon completion of its task(s). Embodiments of the invention may use one or more ACPI Notify command(s) to initiate the transfer of control. The Notify command requests that the operating system loan a selected processor(s) to the firmware until it is returned. The Notify command may be initiated by an AML method of the ACPI, as an event to the selected or target processor or CPU device as named in the ACPI namespace. The Notify command requests delivery of a specific SAL PMI to a selected processor(s). The specific PMI event may be identified by the value of the Notify command (e.g. 0×C1, 0×C2, or 0×C3). As with any AML Notify command, the OS may refuse, ignore, or may grant the request. Correct implementation of the specific definition of this command ensures that the OS can guarantee its safety and sovereignty over resource management. If granted by the OS, Notify command semantics (which may utilize a PMI transfer of control) ensure that firmware has full control of the borrowed processor until relinquishing control back to the OS. The firmware may be able to use the borrowed CPU as long as needed (or necessary) to execute platform-specific firmware within an ACPI sequence. Return of the processor from firmware to OS is may be achieved through the PAL-architected return from the PMI event, which returns to the interrupted instruction. Thus, CPU borrowing becomes a safe, explicit, and collaborative system function, while reducing development costs on both sides of the interface.

Note that the values of the Notify command may be selected from the ‘reserved’ section of Notify values. This reduces the probability of a collision with other OEM vendors or firmware teams choosing to apply non-standard semantics to these values. The low order 2 bits correspond directly to the SAL PMI level to be delivered, i.e. 0×C1 corresponds to PMI level 1, 0×C2 corresponds to PMI Level 2, and 0×C3 corresponds to PMI Level 3.

Also note that there may be no time limit on how long the firmware may borrow the processor. Thus, if the OS has chosen to support the borrow event, and allow the firmware to borrow the processor, it is for ‘as long as needed’. If the OS does not grant unconstrained use of the processor, then the semantics could differ by OS version. For example, WINDOWS may have one time limit, while HPUX may have another, etc. The OS may be written to tolerate the unconstrained use of the processor. Therefore, even if the firmware has a bug and never returns the processor to the OS, the OS will not fail fatally. The intentional omission of a time limit also minimizes surprise because of the clear semantics dividing the use interval between OS and FW and the unambiguous transfer of ownership of the processor from OS to FW and back to OS.

Embodiments of the invention allow the existing system to handle undiscovered problems through the execution of a function(s) in the firmware with a borrowed processor. Thus problems, e.g. a design defect, that would have required a new or modified OS function and corresponding interface can be addressed in firmware. Moreover, embodiments of the invention may provide a standards-compliant system that minimizes OS development costs and may avoid significant architectural changes to ACPI. Embodiments of the invention may preserve the safety of the OS and may preserve the sovereignty of the OS over runtime resource management. Embodiments of the invention may define at least one device specific Notify command parameter(s), thus avoiding using firmware interface extensions that would require time-consuming political and technical activities in their implementation, as well as avoiding the development of a OS-specific kernel driver(s). Embodiments of the invention may use existing (and tested) firmware that already contains functionality to program necessary chipset elements. Embodiments of the invention may permit corrections to be made without having to redesign the hardware, e.g. chipset hardware, along with the consequential program delay. Embodiments of the invention may minimally impact the OS, and can be unilaterally obsoleted by a system developer. Embodiments of the invention may decouple the evolution of the OS and hardware, thus new systems can be developed from modifications in the OS and/or the hardware. This simplifies development of new systems and reduces their costs. This avoids the costly (and time consuming) political and developmental meetings between implementation teams on each side of the hardware/OS interface which would be required in many alternative solution concepts (e.g. new SAL procedures, new ACPI language semantics, new instruction set semantics, etc.). Decoupling product evolution from political process enables competitive value differentiation while still employing standard interfaces. Moreover, by remaining 100% standard (every box is identical), then no value-differentiation is obtainable. Embodiments of the invention may allow firmware to borrow a processor with the permission of the OS, rather than stealing a processor without informing the OS by using a PMI event, and thus avoids the commensurate risks of causing an OS failure. Embodiments of the invention can operate in uniprocessor systems as well as multiprocessor systems. Embodiments of the invention can operate with a standards-compatible HotPlug sequence. Thus, the operating system may safely execute core firmware to perform reprogramming of the hardware within an ACPI-standard, collaborative HotPlug sequence to add or remove cells or other system boards (e.g. I/O chassis), without changing the firmware architecture or the hardware architecture, without stealing a processor, and without having to develop a great deal of code.

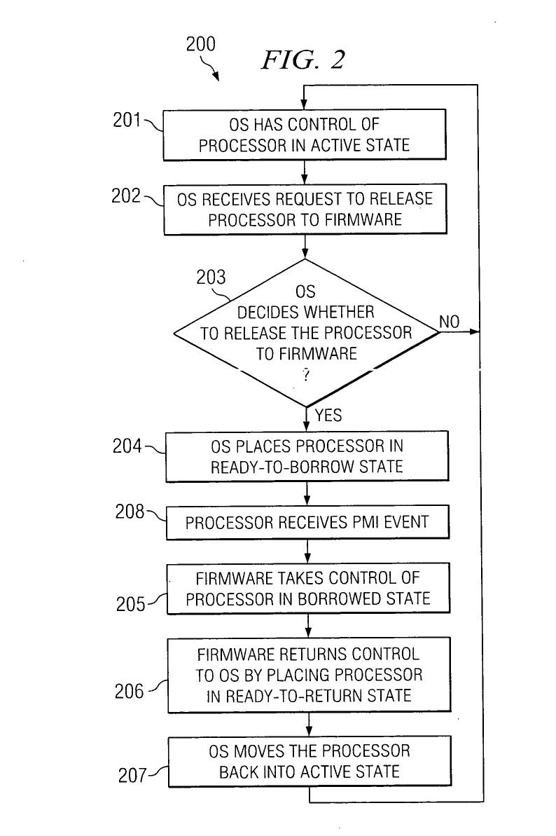

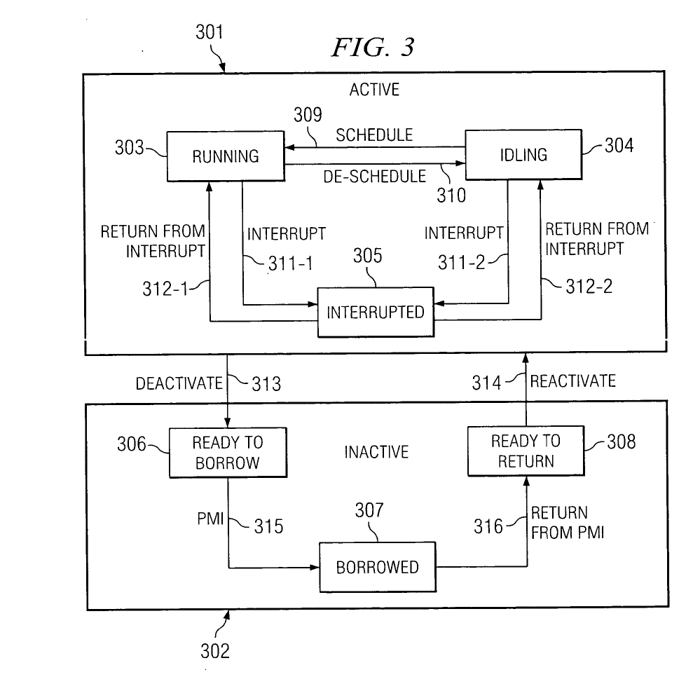

FIG. 2 depicts an example of a method of operation according to embodiments of the invention. In step 201, the OS has control of the processor, and the processor is operating in the active state. Note that the system may comprise one or more processors. The active state is further described with regards to FIG. 3. During its operations, the OS would receive a request to release control of the processor, as shown in step 202. Note that the request may specify the sole processor of a single processor system, any processor of a multi-processor system, a specific processor of a multi-processor system, a plurality of processors of a multi-processor system (either any or specific ones), or all of the processors of a multi-processor system. The request may be in the form of a ACPI Notify command, e.g. Notify (cpudev, O×CL), where cpudev references one processor. Multiple processors may be specified by using a grouped sequence of Notify commands issued together. Note that although the ACPI firmware may invoke the Notify command, other firmware or applications may instruct the ACPI firmware to invoke the Notify command to perform the borrow request. For example, a user-level application may be used to invoke the Notify command. Thus, this would allow a user-level application to invoke a non-standard, but platform-specific firmware service using the PMI event as a proxy pattern.

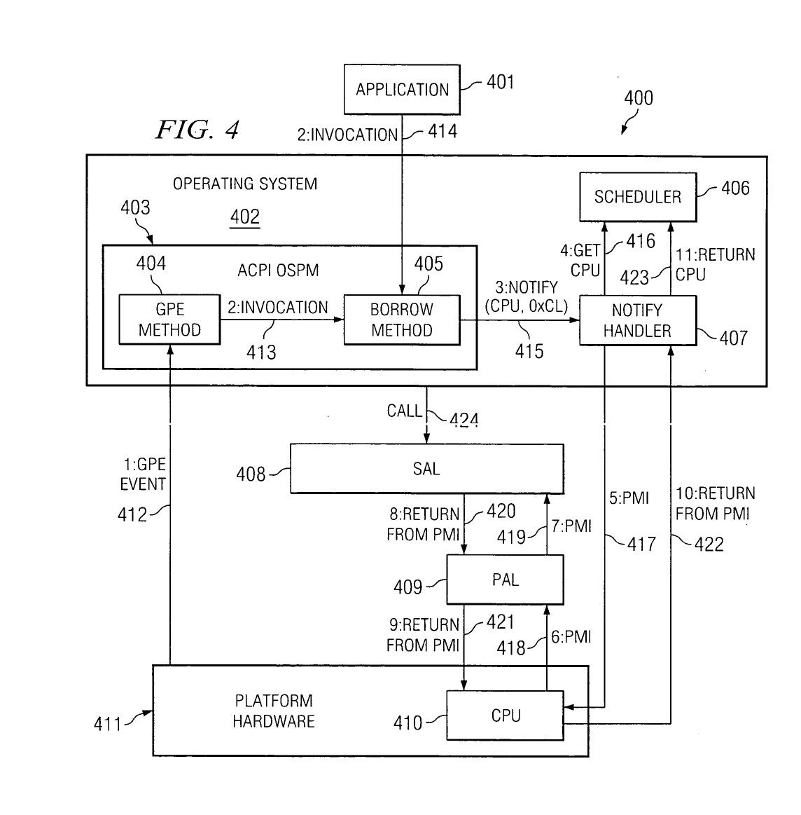

The OS then decides whether to release control of the processor to firmware, as shown in step 203. The firmware cannot force the OS to release the processor, as such a release is at the discretion of the OS. The OS may posses a scheduler mechanism, e.g. the scheduler 406 shown in FIG. 4, that supports the active 301 and inactive states 302 illustrated in FIG. 3. An embodiment of the OS software that supports these states may include subroutines that provide an interface between the ACPI subsystem 403 and the OS Kernel Scheduler Subsystem 406. The subroutines may have semantics such as RemoveCPUFromNormalScheduling(CpuIdentifier, RoutineToExecute) and AddCPUToNormalScheduling(CpuIdentifier). This may provide the interconnection between the ACPI subsystem and the OS Scheduler that may allow the borrow process to operate.

As stated earlier, the OS may ignore the request. Upon a timeout, the firmware may resend the request, or send another request that specifies a different processor or group of processors, until the borrow request is granted for one of the CPUs. If more processors loaned for the borrow request than are required, the excess are returned to the OS. Note that the OS may have more than one pending request, and may grant one or more requests, while refusing one or more other requests.

If the OS grants the request, the OS places the processor into the Ready-to-Borrow state, as shown in step 204. This state is further described with regards to FIG. 3. Before the firmware uses the borrowed processor in step 204, the processor receives the PMI event in step 208. Before receiving the PMI event, the targeted processor may be executing kernel code, even if the processor is in the ready-to-borrow state (which may be a do-nothing loop). After receiving the PMI event, the processor begins executing firmware. Note that the IPF architecture causes the processor to execute some PAL firmware before the SAL firmware execution. For related information on this action, see FIGS. 11-2 and 11-3, along with the accompanying text, as well as chapter 5, of the “Intel Itanium Architecture Software Developer's Manual”, which is hereby incorporated by reference. Note that from the PAL layer's perspective, the processor is merely passing through to the SAL layer. Moreover, the PAL layer may have no concept of the goal-oriented purpose of PMI events, which by architecture, are platform specific.

The SAL firmware would then take control of the processor, and thereby place the processor in the Borrowed state, as shown in step 205. This state is further described with regards to FIG. 3. The firmware would then use the processor to execute code under the control of the firmware. This would allow the SAL firmware to program control register resources to achieve a purpose that cannot be performed by the OS, by the ACPI, or even by a platform-specific device drivers added to the OS. For example, this may be because the registers are not visible to the OS because they are not described or describable to the OS using ACPI standard _CRS objects. The registers may also not be accessible by ACPI, because the registers require load/store primitives (e.g. 64 bits) that are not supported by the OS. The registers may be located in critical sections that cannot be accessed by the OS or ACPI operations. Also, in addition to changing the register settings, core firmware data structures may need to be updated (e.g. simultaneously with the register settings) to reflect these changes, and the data structures are only changeable by the core firmware and not by ACPI or OS.

Note that there may be no limit on the duration of control of the processor by the firmware. After the firmware has completed its task(s), the firmware returns control of the processor back to the OS by placing the processor in the Ready-to-Return state, as shown in step 206. This state is further described with regards to FIG. 3. The OS then moves the processor back into the Active state, as shown by step 207. The OS then has control of the processor in the Active state, as shown in step 201.

FIG. 3 depicts a state diagram for a processor 300 according to embodiments of the invention. The state diagram includes two super states, i.e. the active state 301, and the inactive state 302. Each of the super states includes three sub-states. Note that two super states and six sub-states are shown by way of example only, as other states could exist depending upon the design of the processor 300 and/or the operating system of the platform that comprises the processor. Also note that FIG. 3 is depicting the states of a single processor, however embodiments of the invention will operate with multiple processors.

The active state 301 is the super-state containing all sub-states and transitions whereby the processor is under full policy control of the operating system software. The running sub-state 303 is the state in which the processor is executing non-interrupt-level useful-work software either in the OS kernel itself or in an application level program. The idling sub-state 304 is the state in which the processor is waiting for useful work to do but is under full policy control of the operating system. The interrupted sub-state is the state in which a processor is executing interrupt-level useful work either in the OS kernel itself or on behalf of an application level program.

The transition from the idle state 304 to the running state 303 is referred to as the schedule transition 309. This transition is initiated by the OS's scheduler mechanism(s) and moves the processor from the idle state 304, where no useful work is done by the processor, to the running state 303, in which useful work is performed. Similarly, the transition from the running state 303 to the idle state 304 is known as the de-schedule transition 310. This transition is initiated by the OS's scheduler mechanism(s) to move the processor from the running state 303 to the idle state 304. The transition from either the running state 303 or the idling state 304 to the interrupted state 305 is known as the interrupt transition 311-1 or 311-2, respectively. This transition is initiated by the processor's interrupt mechanism(s) and moves the processor into the interrupted state 305, where OS kernel interrupt handlers (or firmware) continue processing the event until control is returned from the interruption event. Similarly, the transition from the interrupted state 305 to either the running state 303 or the idling state 304 is known as the return-from-interrupt transition 312-1, 312-2, respectively. This transition is initiated by the interrupt handlers and moves the processor from the interrupted state 305 back into the context where the interrupt event occurred. In an interrupt involving MCA handlers, firmware does perform the Return from Interrupt (312-1, 312-2) and continues execution in the kernel code. The MCA interrupt sequence is typically defined by the IPF architecture.

The inactive state 302 is the super-state containing all sub-states whereby the processor is not under full control of the OS. The ready-to-borrow state 306 is a transitional state where the processor is under the control of the OS, in that it is executing OS kernel software, but is no longer active in that the processor is no longer performing tasks for the OS. The control of the processor is being offered to the firmware. Note that in an embodiment, the duration of this state may be extremely brief, perhaps only one cycle. Further note that as described in FIG. 2, the OS is responsible for choosing whether or not to place the processor in this state; the firmware cannot force the processor to enter this state. The Borrowed State 307 is the state in which the processor is under control of the firmware, and the firmware is executing code on the borrowed processor. The firmware has the responsibility for returning control of the processor to the OS, but the duration of this state may then be open-ended. In other words, the firmware will return the processor, but may not be obligated to return the processor immediately or within some predetermined time period. Note that it is expected that duration of this states actual use will be reasonably brief, but the OS should be able to tolerate a potentially infinite duration. Also, during the Borrowed State, the processor will not be able to experience interruptions other than a machine check abort (MCA). If a MCA occurs on a processor while it is in the borrowed state, the firmware should not enter the architected OS_MCA handler. Since the OS has relinquished control of the processor, then the OS does not have any responsibility to handle MCA events on that processor. The firmware may log the MCA (if possible), but since on IPF platforms interruption collection is typically disabled by platform management interrupt (PMI), recovery from the MCA is not guaranteed. In other words, the processor may never return from the Borrowed state if an MCA occurs while it is in that state. The Ready To Return state 308 is another transitional state, similar to state 306, in which the processor passes from the control of firmware back into control by the OS. Like the Ready To Borrow state 306, this state may have an extremely brief duration, depending upon the implementation of the OS. Note that state 308 (along with transition 314) are optional, as control may be returned directly from state 307 to state 301 via transition 316.

The transition from the active state 301 to the ready-to-borrow state 306 is referred to as the deactivate transition 313. This transition is initiated by the OS, whereby the processor yields control to some other policy agency, e.g. the firmware. Note that the deactivate transition may be used to switch control to other entities, e.g. in IPF systems, the deactivate transition is used by the OS to move a processor into a low-power state using architected or implementation specific transitions supported by the IPF processor. See section 11.6 of the Intel® Itanium™ Architecture Software Developer's Manual Vol. 2 rev 2.0. System Architecture, which is hereby incorporated herein by reference. The transition from the ready-to-return state 308 to the active state 301 is referred to as the reactivate transition 314. This transition moves the processor from the Ready-to-Return state back into the Active state where the operating system regains full control of the processor resource. The transition from the ready-to-borrow state 306 to the borrowed state 307 is referred to as PMI transition 315. This transition may be initiated by the OS, and moves the processor into the control of the firmware. In IPF platforms, the firmware most likely to take control of the processor is the system abstraction layer (SAL) firmware, thus transition 315 may be referred to as SAL PMI.

Note that a SAL PMI is a PMI event with a vector priority is 0, 1, 2 or 3. PMI 0 is an interruption delivered by an electrical signal into an individual processor. Each CPU in a multi-processor system has its own electrical signal interrupt for PMI 0. PMI levels 1, 2, 3 are deliverable by a PMI message, either initiated by the CPU-to-CPU IPI (interprocessor interruption) mechanism or from an IOSAPIC programmed to send the PMI message. A different functional purpose may be assigned to each level, and the firmware that receives the interrupted processor knows, by checking the PMI level that PAL gives it upon entry to the SAL PMI code, which of 3 functions that is being multiplexed through this vector. This makes interrupt handling code simpler to implement. Thus, all three values of Notify( ) are defined to allow the AML borrow method to be able to direct any one of the three functional purposes using the borrow mechanism without the OS involvement. In other words, the OS and ACPI function as proxies to carry a message (of the three possible messages) from AML borrow method to the SAL via the PMI mechanism. Alternatively, this mechanism can be used to carry more than three messages, by using AML to ‘store’ a “command message” into a memory buffer through an operation region, and then subsequently accessing this buffer during the PMI handler in SAL. This provides an indefinitely extensible semantic while preserving the existing syntax of the interface. Thus, the firmware may evolve or otherwise be modified, but the OS, once it implements an embodiment of the present invention, will not have to be modified to accommodated evolved firmware.

Further note that the OS, not the platform, initiates the PMI event, after it places the processor in the Ready-to-Borrow state. This transition yields control of the processor to the firmware policy until firmware returns control through the architected transition, Return From PMI. Thus, the OS controls when the PMI 315 is delivered to the processor. The transition that moves the processor from the borrowed state 307 to the ready-to-return state 308 is referred to as the return-from-PMI transition 316. This transition is initiated by the firmware, and readies the processor for the return of control to the OS.

FIG. 4 depicts an example of an arrangement of a system or platform 400 according to embodiments of the invention. The system or platform 400 comprises various objects, associations, and messages, as shown. Note that other objects, messages, and associations may exist, and those shown are by way of example only. The objects are shown as boxes, and represent the various components of the system, e.g. applications, OS, firmware, and the hardware. Note that objects may contain other objects, e.g. the OS 402 includes the notify handler 407. The associations are the lines interconnecting the objects. The messages are labeled arrows and move in the direction indicated by the arrow. The messages are sent between objects and travel on the associations.

Application 401 may be a software entity that performs one or more specified functions, as defined by its code. For example, application 401 may be a management application that manages an aspect of the operation of the platform 400. The application 401 may request that control of a processor shift from the OS to firmware, if the application is an ACPI-aware application. Thus, application 401 is one entity that may initiate a hardware reconfiguration sequence. The application 401 would use an invocation message 414 to request such a change. The message would initiate the borrow method 405 of the OS 402. Alternatively, the application may indirectly invoke the borrow method as a consequence of performing some standard ACPI operation, such as calling the _EJ0 (eject) method on a cell, which then requires the firmware system to execute core firmware as part of the operation.

The platform 400 would also include OS 402, which is the system software component that directs the operations of the platform. An example of an OS is WINDOWS NT by Microsoft. The OS may also be other programs types, e.g. a diagnostic program or a manufacturing program. The OS may include ACPI OSPM 403, which is an ACPI subsystem within the Operating System. It contains the ACPI namespace (not shown) and the AML interpreter (not shown) and also interfaces to various event handlers (not shown) in other parts of the operating system.

The ACPI namespace may include GPE Method 404, which is an AML general-purpose event (GPE) method (written by the hardware OEM compiled into the ACPI namespace by the OSPM) that is invoked by the ACPI OSPM in response to a GPE interrupt message 412 from the platform hardware 411. Each valid GPE interrupt message supported by the platform firmware has a corresponding method in the namespace which is invoked by the operating system when the event is signaled. The GPE Event message 412 is signaled to the AML system through the OS system using a normal shared interrupt, e.g. the SCI interrupt (system control interrupt). The OS de-multiplexes multiple GPE events by reading architected register bits in the platform and matching the corresponding GPE method in the ACPI namespace, then invoking that method using the AML interpreter. One (or more) GPE event messages may cause the invocation of the borrow method 405. The GPE event message 412 would be received by GPE method 404, which then issues an invocation message 413, similar to message 414, which is delivered to the borrow method 405. Message 413 indicates an invocation (or execution of interpreted AML) of one AML method by another AML method. In this case, the GPE method 404 invokes the borrow method 405.

The ACPI OSPM 403 may include Borrow Method 405 which is an AML method that facilitates the change in control of a processor or processors from the OS to firmware. This method may be invoked by other methods, e.g. GPE method 404, or by applications, e.g. application 401. The method, after invocation, produces the notify message 415. Note that the Borrow Method 405 may be part of the OS, or it may be a separate method that is imported into the ACPI namespace when the namespace is initialized. In either event, Notify( ) is a command that that is encoded into the Borrow Method 405. Note that the Notify( ) command may be in the form of ‘Notify(\_SB_.N000.P003, 0×C1), which encodes the notify opcode in AML binary form, and passes two arguments, a reference to CPU (e.g. CPU 3) and the PMI level event argument (e.g. PMI Level 1). Note that this is an example only, and in actual systems, the device path could be something different. The device path specified should refer to an ACPI 2.0 Processor Device object, and that the Notify Command value should be one of 0×C1, 0×C1, or 0×C3.

The Borrow Method 405 may comprise one or more AML methods that operate together before executing the Notify( ) command (415). Note that some of these AML methods may have other functions, but are shown as Borrow Method 405 for purposes of illustration only. The selection of the target processor, and the decision as to whether or not to send the Notify( ) command may be determined by the Borrow Method 405. In some instances, only certain processors are capable of performing certain work inside a PMI handler, while other processors cannot. If the Borrow Method does not make the selection, then the OS would make the selection based on its preference, e.g. a lightly used processor. However, the selected processor may not be able to perform the desired task. Therefore, embodiments of this invention allow the AML borrow method to specify a specific processor so that the Operating System need not comprehend hardware-specific asymmetry in processor capabilities. While the OS may refuse to grant the desired request, and thus prevent the function from happening, the alternative of encoding platform specific knowledge into OS code is very costly and eventually also limiting as systems evolve through subsequent generations of hardware and operating system releases.

The notify message 415 indicates that the firmware is requesting the OS to release control of the specified processor to the firmware. Note that the OS ‘agrees’ to release the processor to firmware at the very point that the PMI message is executed, in message 417, which is potentially later (in time) than when message 415 is sent from the AML method 405 to the Notify Handler 407. The notify message 415 indicates that the OS has agreed to release control of a processor to the firmware. The notify message 415 may have the format of Notify(cpu, O×CL), where cpu is a designation for the processor or processors that the OS will release control of, and L specifies the PMI level to be used in the inter-processor interrupt (IPR), and is 1, 2 or 3. Thus, there may be three ‘borrow’ commands, namely 0×C1, 0×C2, and 0×C3, corresponding to the SAL PMI levels 1, 2 and 3, respectively.

The OS may include scheduler 406, which is the subsystem that contains code and data structures responsible for efficiently sharing resources (e.g. processors) among multiple, concurrent program threads (e.g. applications or user applications) within and without the operating system. Note that although any privileged software in the kernel, or platform hardware designed to do so, is capable of initiating a PMI event, doing so without the consent and cooperation of the system scheduler is likely not to function very well if at all.

The OS may include notify handler 407, which is a proxy agent between the ACPI request to borrow and the functionality within the operating system capable of granting the request (e.g. the scheduler 406). Handler 407 is responsible for accepting the Notify message 415, communicating with the scheduler object, and if the request is granted, for managing the delivery of the PMI to the target processor, and its ultimate return back to control of the scheduler when firmware finishes borrowing it. The handler 407 will generate the Get CPU message 416, which is delivered to the scheduler 406, and is an OS request to remove the specified processor from the normal active mode and ready it for borrowing mode. When the message returns and the request is granted, the specified CPU is inactivated. Note that this aspect is OS dependent. For example, HPUX includes a subsystem known as the ‘Processor Resource Manager’ (PRM) which embodies code that would fulfill the functions of the scheduler 406, the notify handler 407, and messaging 416 and 423, namely the inactivation of the target processor. For example, interrupt messages, co-routines, and/or state machines can be used to inactivate the processor. However, whichever mechanism is used, the OS needs to allow the firmware to borrow the processor for any duration of time and still be stable.

After the processor is in the inactive mode, e.g. ready to borrow state 306, the handler 407 generates the PMI message 417, which is delivered to the specified processor 410 in the platform hardware 411. The PMI message 417 is a IPR to the target processor using one of the SAL vectors (1, 2, or 3). The level of the interrupt to use is specified by the notify command (0×C1, 0×C2, or 0×C3). When the firmware is done with the processor, the handler 407 generates the return CPU message 423, which is delivered to the scheduler 406, and indicates the transition of control of the borrowed CPU back to the OS, e.g. reactivate transition 314.

The platform 400 may include system abstraction layer (SAL) firmware 408. This architecturally required system firmware element contains platform specific firmware responsible for initializing the platform and providing the SAL procedure call services and interface to PAL 409. This is the firmware layer that may take control of the processor and handle the PMI event indicated by message 419. Note that the SAL layer is using the processor and is handling the PMI event, and semantically is borrowing the processor. The borrow method is issuing the Notify( ) command that causes the borrow event. In other words, in the borrow event or borrow sequence, the AML Borrow Method chooses the processor and forms the Notify 0 command or the request to borrow, while the SAL firmware handles the functional purpose of the borrow and returns the CPU to the OS when the purpose is complete. The OS maintains the borrow policy, deactivates the CPU, initiates the PMI event, and reactivates the CPU.

When finished with the processor (e.g. the PMI event is complete), the SAL forms the return from PMI message 420 that indicates that the OS can take back control of the processor. Note that the SAL layer may receive a call message 424, which is another way for the OS to invoke the SAL firmware, and represents a procedure call to one of the SAL procedures by the operating system.

The platform 400 may include processor abstraction layer (PAL) firmware 409. The layer contains processor dependent initialization firmware that is typically developed by the processor vendor. The PAL layer receives the PMI event 418 from the processor CPU, and passes the event 419 on to the SAL layer 408. Note that the PAL firmware first gains control (begins executing) in response to PMI events accepted by the CPU. For further information on the interaction between the PAL and SAL firmware layers, see chapters 5 and 11 of the “Intel Itanium Architecture Software Developer's Manual”, which is hereby incorporated by reference. The sequence is that, first, the OS causes an inter-processor interrupt using PMI level 1, 2 or 3 that is to be sent to the targeted processor. This is architected by hardware. Next, the interrupt causes the target processor to switch to physical mode and branch into PAL. This is architected by hardware. Next, the PAL executes and does minimal state saving according to the SAL-PAL interface definitions for the system. Next, the PAL transfers control into SAL, if the SAL had previously registered its PMI entry point for that CPU. This is architected by firmware. Next, the SAL executes on the borrowed processor, and when complete, the SAL invokes the PAL ReturnFromPMI function. This is architected in firmware. Next, the PAL returns to the interrupted instruction inside the OS. This is architected in hardware and firmware. At this point, the OS handler 407 notices the processor is back and reactivates the processor to resume using the CPU normally.

The PAL layer also receives the Return from PMI message 420 from the SAL layer, and passes the message 421 onto the processor 410. Message 421 indicates the transition from PAL controlling execution to the Processor controlling execution. This will be the last machine instruction that PAL executes following restoring of the processor state in order to resume execution at the instruction that was interrupted by the PMI event message 417.

The platform may include platform hardware 411, which is the hardware of the computer system, including the processor 410. Note that there may be one or more processors. The processor would receive the PMI message 417, and branch to the PAL PMI entry in the PAL layer. For more information on this action, see FIGS. 11-2 and 11-3, along with the accompanying text, as well as section 11.5 of the “Intel Itanium Architecture Software Developer's Manual”, which is hereby incorporated by reference.

The processor then passes the PMI message 418 onto the PAL layer 409. The processor also receives the return from PMI message 421 from the PAL layer 409, and passes on return from PMI message 422 to the handler 407. Message 422 indicates that the processor is resuming execution at the interrupted instruction. The visible processor state is required to be identical to its state when the PMI event 417 occurred. Note that embodiments of the invention may operate on a system in a single processor. During the period the processor is borrowed, the OS would be in a state of ‘suspended hibernation’ similar to the state that the same uniprocessor OS would exist in when it voluntarily invoked the PAL_HALT command, i.e. to conserve power when there is no useful work to do. An OS that contains a scheduler that is capable of suspending its execution to take advantage of the PAL_HALT command can also support borrowing its sole processor to achieve a useful system function.

What is claimed is:

1. A method for changing control of a processor that is in an active state under the control of an operating system to a borrowed state wherein the processor is under control of firmware, comprising:
sending a request for a change in control to the operating system;
deciding, by the operating system, whether to grant the request;
placing the processor in a transitional state that is different from the active state, if the request is granted; and
sending, by the operating system, an interrupt signal to move the processor from the transitional state into the borrowed state.

2. The method of claim 1, further comprising:
maintaining the processor in the active state, if the request is denied.

3. The method of claim 2, further comprising:
re-sending the request, if the request is denied.

4. The method of claim 1, further comprising:
operating the processor in the borrowed state until completion of a task;
placing the processor in another transitional state; and
returning the processor to the active state.

5. The method of claim 4, wherein the task is handling a problem that cannot be handled by the operating system.

6. The method of claim 1, wherein the processor is one processor of a plurality of processors.

7. The method of claim 6, wherein the request specifies the processor.

8. The method of claim 1, wherein a duration of the borrowed state is unbounded.

9. The method of claim 1, wherein the request is an notify command referencing the processor.

10. The method of claim 1, further comprising:
invoking the request by one of the firmware and an application.

11. The method of claim 1, further comprising:
using a general purpose event to cause formation of the request.

12. The method of claim 1, further comprising:
placing the operating system into hibernation while the processor is in the borrowed state.

13. The method of claim 1, wherein the processor is an Itanium Processor Family chip, and the firmware is system abstraction layer firmware.

14. The method of claim 1, wherein the deciding comprises:
deciding, by the operating system without involvement of the firmware, whether to grant the request.

15. A computer system comprising:
a processor for executing code;
an operating system that has control of the processor during an active state; and
a firmware layer that has control of the processor during a borrowed state;
wherein the operating system decides whether to place the processor in the borrowed state and sends an interrupt signal to move the processor into the borrowed state.

16. The system of claim 15, wherein if the operating system decides not to place the processor in the borrowed state, the operating system maintains control of the processor.

17. The system of claim 15, wherein the firmware maintains control of the processor in the borrowed state until completion of a task, and then returns control of the processor to the operating system.

18. The system of claim 17, wherein the task involves a problem that cannot be handled by the operating system.

19. The system of claim 15, wherein the processor is one processor of a plurality of processors.

20. The system of claim 15, further comprising:
a requesting entity invokes a request that the processor be placed in the borrowed state.

21. The system of claim 20, wherein the processor is one processor of a plurality of processors and the request specifies the processor.

22. The system of claim 20, wherein the request is an notify command referencing the processor.

23. The system of claim 20, wherein the requesting entity is one of:
the firmware, an application, and platform hardware.

24. The system of claim 20, wherein a general purpose event is used to cause formation of the request.

25. The system of claim 15, wherein a duration of the borrowed state is unbounded.

26. The system of claim 15, wherein the operating system is placed into hibernation while the processor is in the borrowed state.

27. The system of claim 15, wherein the processor is an Itanium Processor Family chip, and the firmware is system abstraction layer firmware.

28. The system of claim 15, wherein the operating system decides without involvement of the firmware whether to place the processor in the borrowed state.

29. The system of claim 15, wherein the operating system acts as a proxy to deliver a message to the firmware layer.

30. The system of claim 15, wherein a modification of the firmware does not require a modification to the operating system.

31. A computer system that has a processor for executing code,
an operating system that has control of the processor during an active state; and
a firmware layer that has control of the processor during a borrowed state, the system comprising:
means for forming a request to change control of the processor from the active state to a borrowed state;
means, operative by the operating system, for deciding whether to grant the request;
means for moving the processor from the active state to the borrowed state.

32. The computer system of claim 31, further comprising:
means for returning the processor to the active state upon completion of a task.

33. A computer readable medium having computer program logic recorded thereon for changing control of a processor that is in an active state under the control of an operating system to a borrowed state wherein the processor is under control of firmware, comprising:
logic for forming a request for a change in control to the operating system;
logic for deciding, by the operating system, whether to grant the request;
logic for placing the processor in a transitional state that is different from the active state, if the request is granted; and
logic for moving the processor from the transitional state into the borrowed state.

34. The computer system of claim 33, further comprising:
logic for returning the processor to the active state upon completion of a task.
